(19) United States
(12) Patent Application Publication
(10) Pub. No.: US 2015/0375786 A1
(43) Pub. Date: Dec. 31, 2015

(54) AUTOMATIC TURNING DECELERATION DEVICE FOR A MOBILITY AID

(71) Applicant: Shu-Chen CHAN, Changhua County (TW)

(72) Inventor: Shu-Chen CHAN, Changhua County (TW)

(21) Appl. No.: 14/318,332

(22) Filed: Jun. 27, 2014

(51) Int. Cl. B62D 15/02; B60K 31/00

(52) U.S. Cl. CPC B62D 15/0215; B60K 31/0075; B60K 2031/0091

(57) ABSTRACT

An automatic turning deceleration device for a mobility aid has a fixing base, a fixing unit, a turning sensor, a turning base, a linking unit, and a control module. The turning sensor is rotatably mounted on a side of the fixing unit. The turning base is mounted around the turning sensor. The linking unit is combined on the turning base and abuts the turning sensor. The control module is mounted on a side of the turning base and links between the fixing base and the turning base. Therefore, the automatic turning deceleration device can provide a stable and steady decelerating effect for the mobility aid.

### BACKGROUND OF THE INVENTION

1. Field of the Invention

The present invention relates to a turning deceleration device, and more particularly to an automatic turning deceleration device for a mobility aid.

2. Description of Related Art

A mobility aid is applied for assisting a user with reduced mobility to move easily. To maintain turning stability for the mobility aid, a proximity switch is mounted on a stem of the mobility aid. The stem is rotated by the user for turning the mobility aid. When the stem is rotated to a default angle, the proximity switch come into contact with a sensor, and then the sensor transmits a deceleration signal to a motor of the controller to control the mobility aid to decelerate and to prevent overturning

However, the deceleration signal is transmitted only when the proximity switch contacts the sensor , such that the motor decelerates promptly in a short time. Therefore, the decelerating effect of the mobility aid cannot be maintained stable and steady.

### SUMMARY OF THE INVENTION

The main objective of the present invention is to provide an improved automatic turning deceleration device for a mobility aid to resolve the above-mentioned problems.

The automatic turning deceleration device of a mobility aid has a fixing base, a fixing unit, a turning sensor, a turning base, a linking unit, and a control module.

The turning sensor is rotatably mounted on a side of the fixing unit. The turning base is mounted around the turning sensor. The linking unit is combined on the turning base and abuts the turning sensor. The control module is mounted on a side of the turning base and links between the fixing base and the turning base.

Other objectives, advantages and novel features of the present invention will become more apparent from the following detailed description when taken in conjunction with the accompanying drawings.

### BRIEF DESCRIPTION OF THE DRAWINGS

FIG. 1 is a partially perspective view of an automatic turning deceleration device in accordance with the present invention, shown mounted on a mobility aid;

FIG. 2 is an enlarged perspective view of the automatic turning deceleration device in FIG. 1;

FIG. 3 is an exploded perspective view of the automatic turning deceleration device in FIG. 2;

FIG. 4 is a front side view in partial section of the automatic turning deceleration device in FIG. 2;

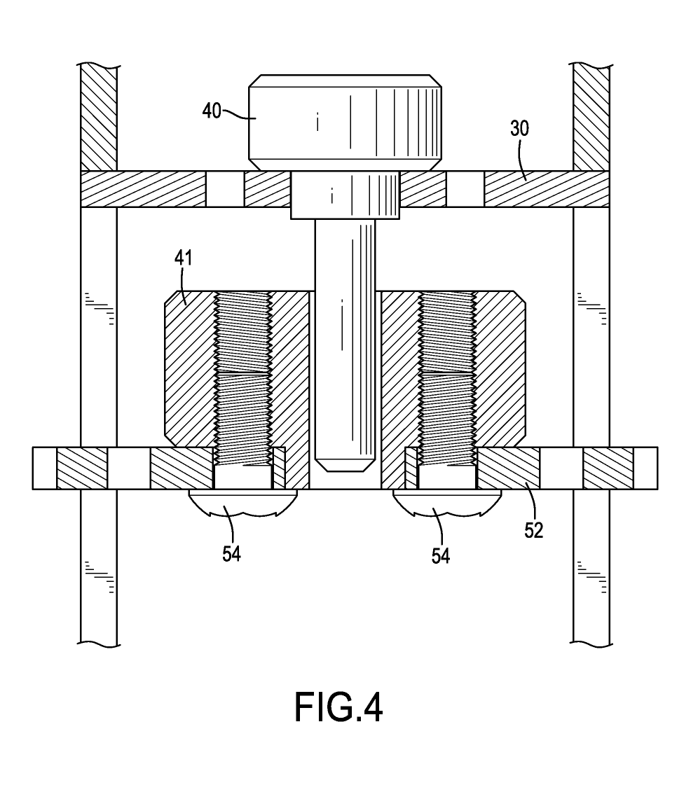

FIG. 5 is a side view in partial section of the automatic turning deceleration device in FIG. 2; and

FIGS. 6A and 6B show operational bottom views of the automatic turning deceleration device in FIG. 2.

### DETAILED DESCRIPTION OF PREFERRED EMBODIMENT

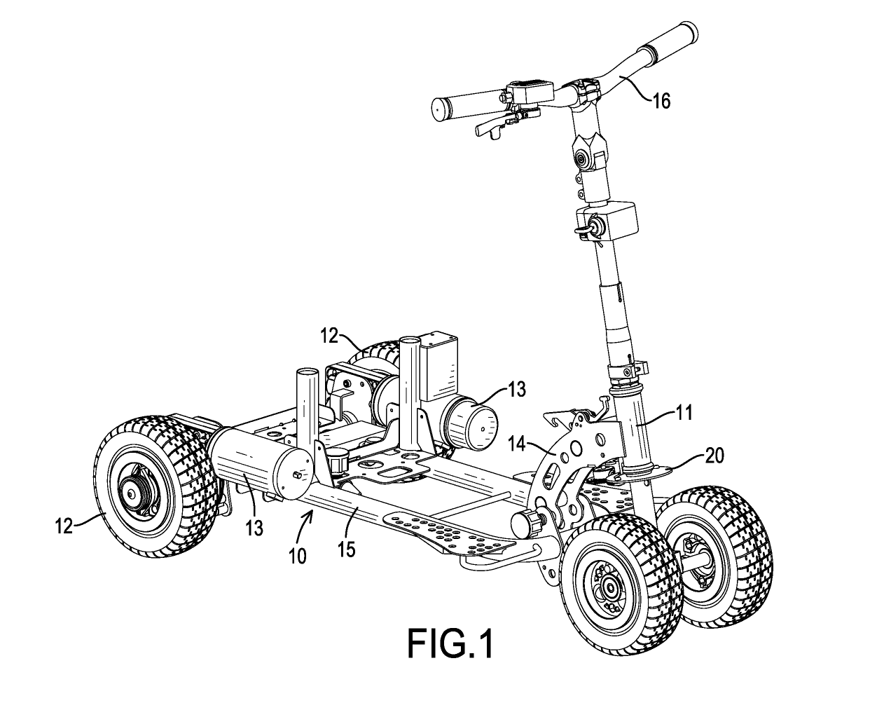

With reference to FIG. 1, a preferred embodiment of an automatic turning deceleration device for a mobility aid in accordance with the present invention is mounted on a bottom of a stem 11 of a mobility aid 10. The mobility aid 10 has the stem 11, a body 15, a handle bar 16, a fixing frame 14, two rear wheels 12 and two motors 13. The stem 11 is mounted on a front side of the body 15. The handle bar 16 is mounted on a top of the stem 11. The fixing frame 14 is mounted on the stem 11 to fix the stem 11 on the body 15, wherein the automatic turning deceleration device is mounted on the fixing frame 14. The rear wheels 12 are mounted on a rear of the body 15 and are respectively located on two sides of the body 15. The motors 13 are respectively mounted on the two sides of the body 15 and respectively drive the rear wheels 12. Alternatively, the mobility aid 10 may only have a motor 13 for driving the rear wheels 12. In use, the automatic turning deceleration device is electrically connected with the motors 13. The handle bar 16 is applied for a user to control a moving direction of the mobility aid 10.

Alternatively, the mobility aid 10 may only has a motor 13 mounted on one of the sides of the body 15 and driving the rear wheels 12.

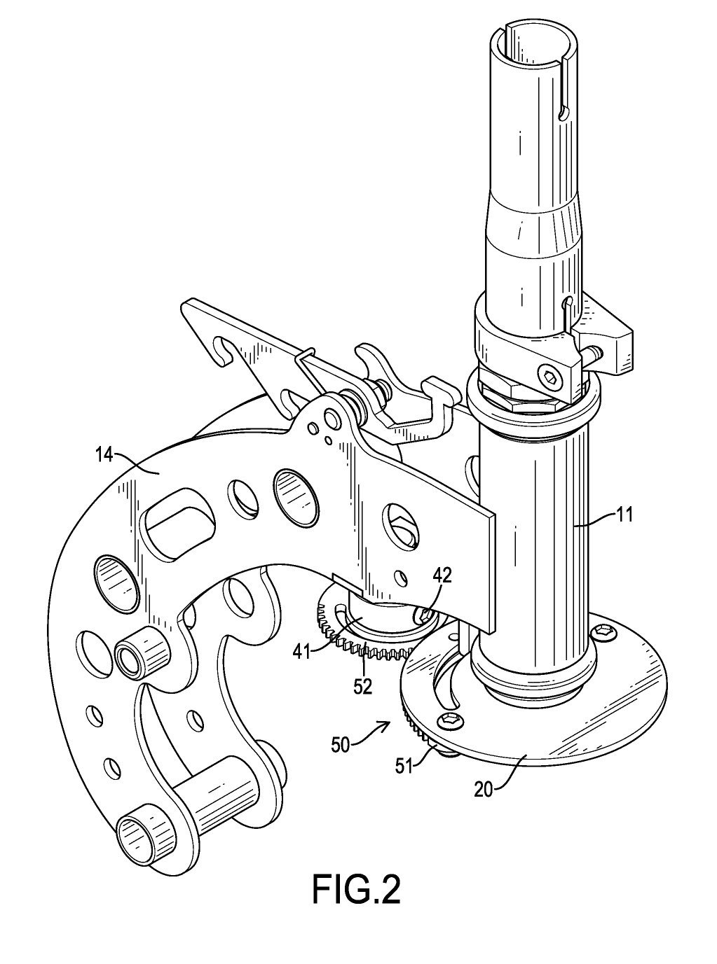

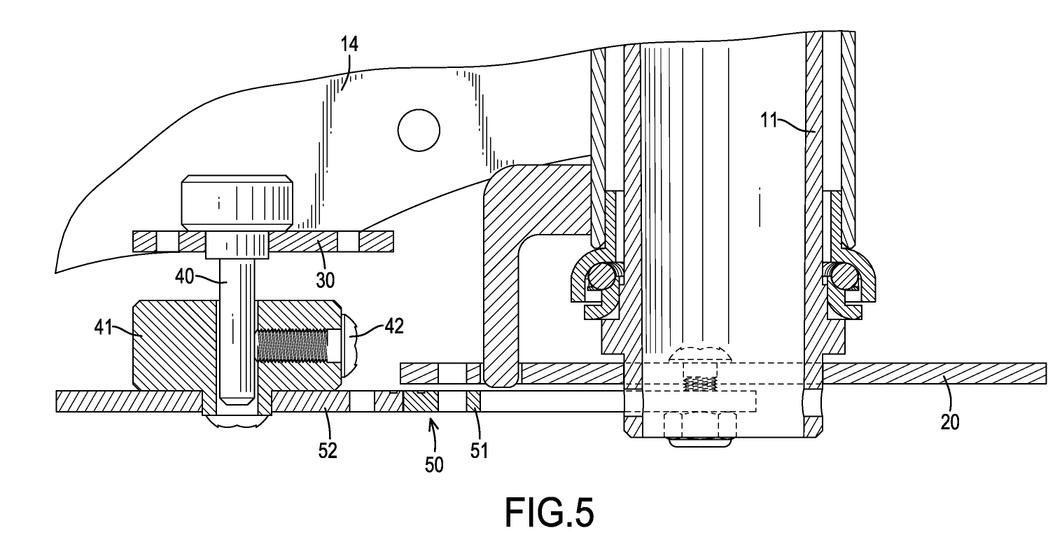

With reference to FIGS. 1, 2 and 5, the automatic turning deceleration device has a fixing base 20, a fixing unit 30, a turning sensor 40, a turning base 41, a linking unit 42 and a control module 50.

The fixing base 20 is mounted on a bottom of the stem 11. The fixing unit 30 is mounted on the fixing frame 14. Preferably, the fixing unit 30 is formed as a fixing plate. The turning sensor 40 is rotatably mounted on the fixing unit 30. The turning base 41 is mounted around the turning sensor 40. The linking unit 42 is inserted into a side of the turning base 41, is combined with the turning base 41 and abuts the turning sensor 40, such that the linking unit 42 can drive the turning base 41 to rotate when the automatic turning deceleration device is turned. The turning sensor 40 is electrically connected with the motors 13. Preferably, the turning sensor 40 is a variable resistor or a potentiometer.

The control module 50 is mounted on the fixing base 20 and a bottom of the turning base 41, and is linked between the fixing base 20 and the turning base 41. The control module 50 has a main control pad 51 and a secondary control pad52. The main control pad 51 is mounted on a bottom of the fixing base 20. Preferably, the main control pad 51 is mounted on the bottom of the fixing base 20 by two bolts 53. The main control pad 51 is formed in a curved shape and has multiple first engaging teeth 511. The first engaging teeth 511 are formed on a side of the main control pad 51 and are arranged at intervals. The secondary control pad 52 is mounted on a bottom of the turning base 41. Preferably, the secondary control pad 52 is mounted on the bottom of the turning base 41 by two bolts 54. The secondary control pad 52 has multiple second engaging teeth 521. The second engaging teeth 521 are formed on a side of the secondary control pad 52, are arranged at intervals, and are engaged with the first engaging teeth 511. When the first control pad 51 is rotated, the second control pad 52 is driven to rotate by the cooperation between the first engaging teeth 511 and the second engaging teeth 521. The linking structure between the control module 50 and the turning base 41 is not restricted in the present invention. The control module 50 may be a linking lever linking between the fixing base 20 and the turning base 41 to drive the turning base 41 to rotate.

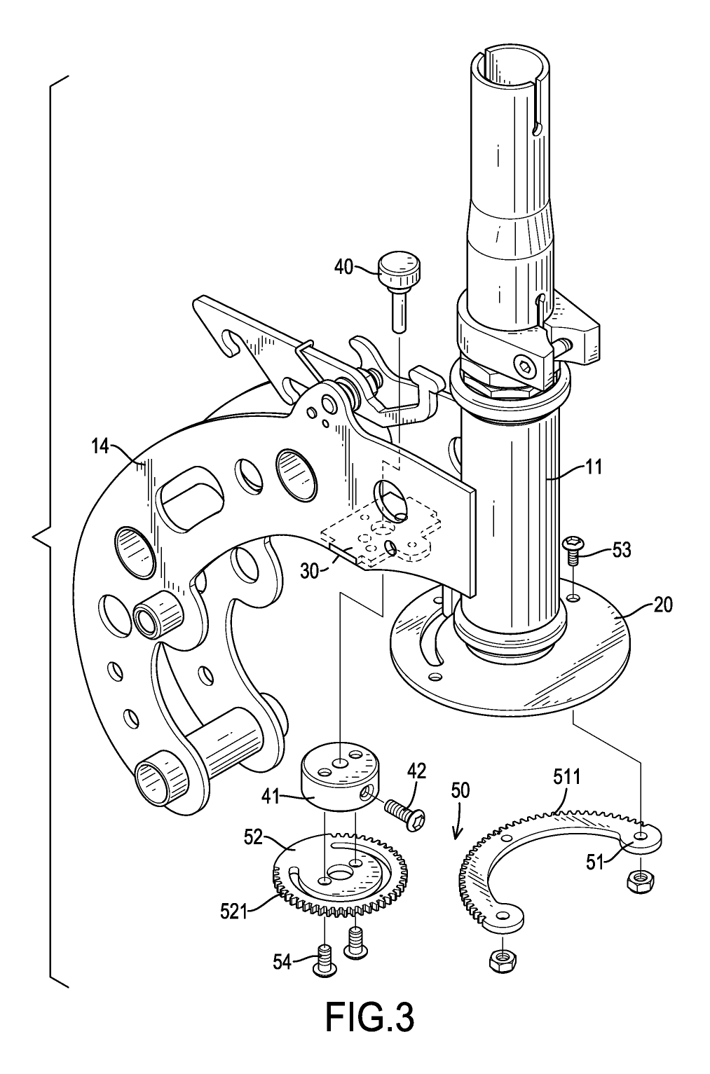

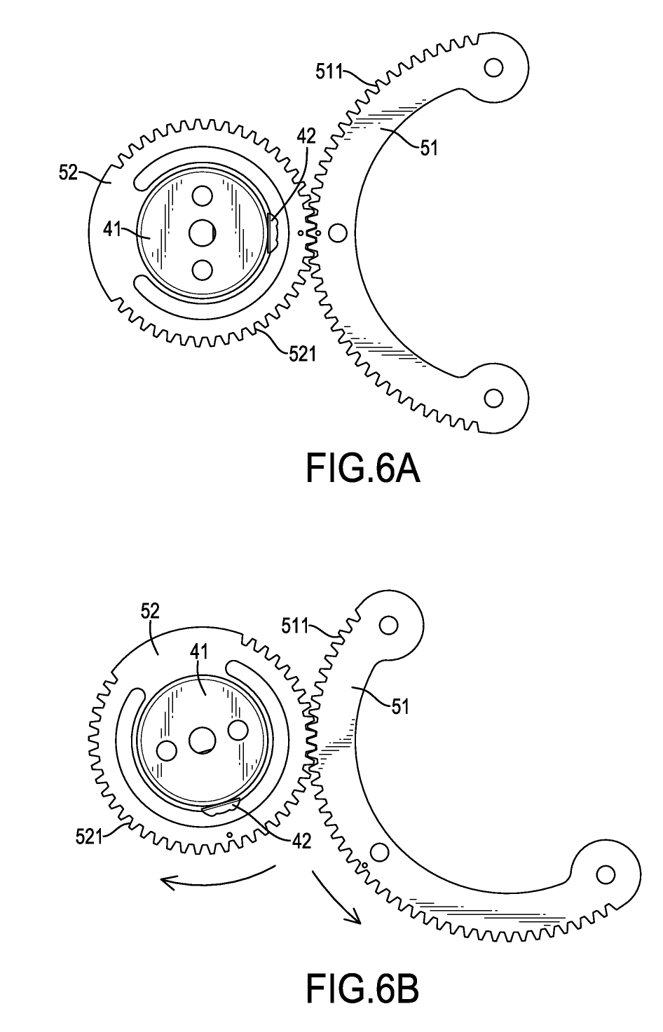

With reference to FIGS. 3, 5, 6A and 6B, in use, when the turning base 41 is not rotated, the turning sensor 40 cannot be driven to rotate, such that the turning sensor 40 cannot transmit a decelerating signal to an electronic control system and the motors 13 of the mobility aid 10. Therefore, the motors 13 operate at a speed that is controlled by a user.

When the user rotates the stem 11 to control the mobility aid 10 to turn left or right, the fixing base 20 drives the main control pad 51 to rotate, and then the main control pad 51 controls the secondary control pad 52 to rotate by the first engaging teeth 511. When the secondary control pad 52 is rotated, the turning base 41 is driven to rotate and then the turning sensor 40 is driven to rotate by the linking unit 42. After the turning sensor 40 is rotated, the turning sensor 40 can transmit the linear decelerating signal to the electronic control system and the motors 13 of the mobility aid 10. As a rotation angle of the turning sensor 40 enlarges, the decelerating signal transmitted to the motors 13 intensifies accordingly, such that the motors 13 can decelerate for a stable and steady turning effect.

From the above description, it is noted that the present invention has the following advantages: In use, the fixing base 20 is mounted on the stem 11 of the mobility aid 10. When the stem 11 is rotated, the fixing base 20 can be rotated to further drive the turning base 41 to rotate by the control module 50. Then, the linking unit 42 is applied for driving the turning sensor 40 to rotate, wherein the turning sensor 40 is electrically connected with the electronic control system and the motors 13 of the mobility aid 10. Therefore, when the turning sensor 40 is rotated, the linear decelerating signal is transmitted to the motors 13. Along with the increasing of the rotation angle of the turning sensor 40, the decelerating effect of the motors 13 becomes enhanced. Therefore, when the mobility aid 10 turns right or left, the automatic turning deceleration device can be applied to control the motors 13 to decelerate steadily, stably and effectively to increase a turning security.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An automatic turning deceleration device for a mobility aid having:
a fixing base;
a fixing unit;
a turning sensor rotatably mounted on a side of the fixing unit;
a turning base mounted around the turning sensor;
a linking unit combined on the turning base and abutting the turning sensor; and
a control module mounted on a side of the turning base and linking between the fixing base and the turning base.

2. The automatic turning deceleration device as claimed in claim 1, wherein the control module has
a main control pad mounted on a side of the fixing base; and
a secondary control pad mounted on the side of the turning base and engaged with the main control pad.

3. The automatic turning deceleration device as claimed in claim 2, wherein the fixing unit is formed as a fixing plate.

4. The automatic turning deceleration device as claimed in claim 3, wherein the main control pad is mounted on the fixing base by two bolts.

5. The automatic turning deceleration device as claimed in claim 4, wherein the secondary control pad is mounted on the turning base by two bolts.

6. The automatic turning deceleration device as claimed in claim 5, wherein the main control pad is mounted on a bottom of the fixing base, and the secondary control pad is mounted on a bottom of the turning base.

7. The automatic turning deceleration device as claimed in claim 6, wherein the main control pad is formed in a curved shape.

8. The automatic turning deceleration device as claimed in claim 2, wherein
the main control pad has multiple first engaging teeth;
the secondary control pad has multiple second engaging teeth; and
the first engaging teeth are engaged with the second engaging teeth.

9. The automatic turning deceleration device as claimed in claim 3, wherein
the main control pad has multiple first engaging teeth;
the secondary control pad has multiple second engaging teeth; and
the first engaging teeth are engaged with the second engaging teeth.

10. The automatic turning deceleration device as claimed in claim 4, wherein
the main control pad has multiple first engaging teeth;
the secondary control pad has multiple second engaging teeth; and
the first engaging teeth are engaged with the second engaging teeth.

11. The automatic turning deceleration device as claimed in claim 5, wherein
the main control pad has multiple first engaging teeth;
the secondary control pad has multiple second engaging teeth; and
the first engaging teeth are engaged with the second engaging teeth.

12. The automatic turning deceleration device as claimed in claim 6, wherein
the main control pad has multiple first engaging teeth;
the secondary control pad has multiple second engaging teeth; and
the first engaging teeth are engaged with the second engaging teeth.

13. The automatic turning deceleration device as claimed in claim 7, wherein
the main control pad has multiple first engaging teeth;
the secondary control pad has multiple second engaging teeth; and
the first engaging teeth are engaged with the second engaging teeth.
